(19) United States
(12) Patent Application Publication
(10) Pub. No.: US 2002/0175610 A1
(43) Pub. Date: Nov. 28, 2002

(54) Lamp assembly

(76) Inventor: Yu-Hua Jong Huang, Chungli City (TW)

Correspondence Address: BACON & THOMAS, PLLC, 625 SLATERS LANE, FOURTH FLOOR, ALEXANDRIA, VA, 22314

(21) Appl. No.: 09/863,307

(22) Filed: May 24, 2001

(51) Int. Cl. H01J 5/48

(52) U.S. Cl. 313/318.05; 313/318.01

(57) ABSTRACT

A high intensity discharge lamp assembly includes a base having a tubular member and a frame is mounted to the tubular member. A plurality of position slots are defined in an outer periphery of the tubular member of the base. A lamp is engaged with the frame and a clamp member has a hole through which the lamp is inserted. A plurality of clamp plates extend from a periphery of the hole and clamp the lamp. A C-shaped clip is engaged with an annular recess of the frame and one of the position recesses of the tubular member of the base. By moving the C-shaped clip, the lamp and the frame adjustably move on the tubular member of the base.

### FIELD OF THE INVENTION

The present invention relates to a lamp assembly for vehicle especially for high intensity discharge lamp assembly. The assembly is easily to adjust its focus to accommodate lamp frames with different brands.

### BACKGROUND OF THE INVENTION

A conventional vehicle headlamp generally includes two functions of high beam and low beam. These two functions are made by having two sets of filaments received in the same lamp of the headlamp. Two filaments make the size of the lamp to be large. Nevertheless, the conventional lamp cannot produce satisfied brightness so that some vehicle manufacturers employ high intensity discharge lamp system which is able to produce higher brightness. The high intensity discharge lamp system a photo conductive capacitor, a metal compound and Xenon, all of which are sealed in a lamp. The metal compound is vaporized into Xenon particles which will produce brightness. The conventional high intensity discharge lamp system is assembled to a frame and the assembly of the high intensity discharge lamp system and the frame are then installed to the vehicle. However, the shapes of frames of different brands of vehicles are not identical so that the manufacturers have to prepare many molds of frames. The conventional high intensity discharge lamp system is made according to a specific vehicle so that other high intensity discharge lamp system cannot obtain a proper focus.

The present invention intends to provide a high intensity discharge lamp assembly wherein the base has many parallel slots defined in an outer periphery thereof and the frame is connected to the frame by a clip engaged with the slots, so that the frame can be movably positioned by engaging the clip with different slots.

### SUMMARY OF THE INVENTION

In accordance with one aspect of the present invention, there is provided a high intensity discharge lamp assembly and comprises a base having a tubular member in which a first recess and a second recess are defined. A frame has a central passage and is mounted to the tubular member. A lamp has an isolation end extending through a clamp member and received in the first recess. The clamp member has clamp plates which clamp the lamp. An isolation rod is connected to the lamp and received in the second recess. A clip connects the frame to the tubular member.

The primary object of the present invention is to provide a high intensity discharge lamp assembly wherein the frame of the lamp is able to be moved on the base so as to obtain desired focus on different types of vehicles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a high intensity discharge lamp assembly of the present invention;

FIG. 2 is a perspective view to show the high intensity discharge lamp assembly of the present invention;

FIG. 3 is a cross sectional view to show the high intensity discharge lamp assembly of the present invention, and

FIG. 4 is another cross sectional view to show the high intensity discharge lamp assembly of the present invention.

### DETAILED DESCRIPTION OF THE INVENTION

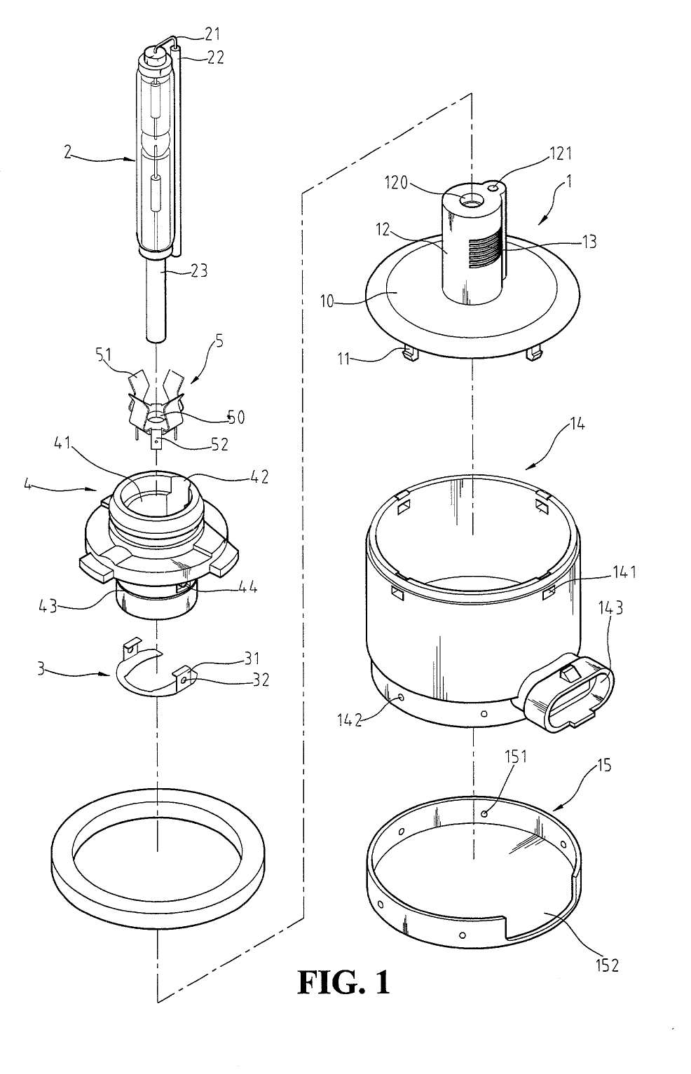

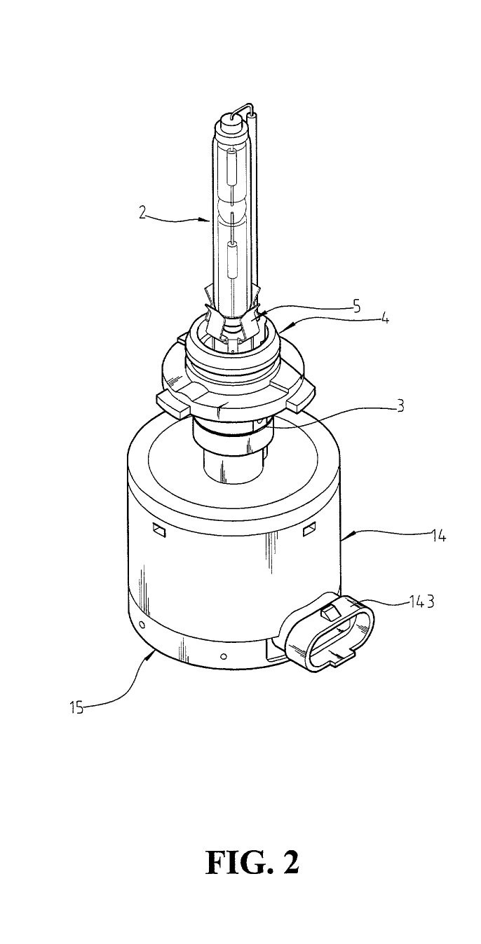

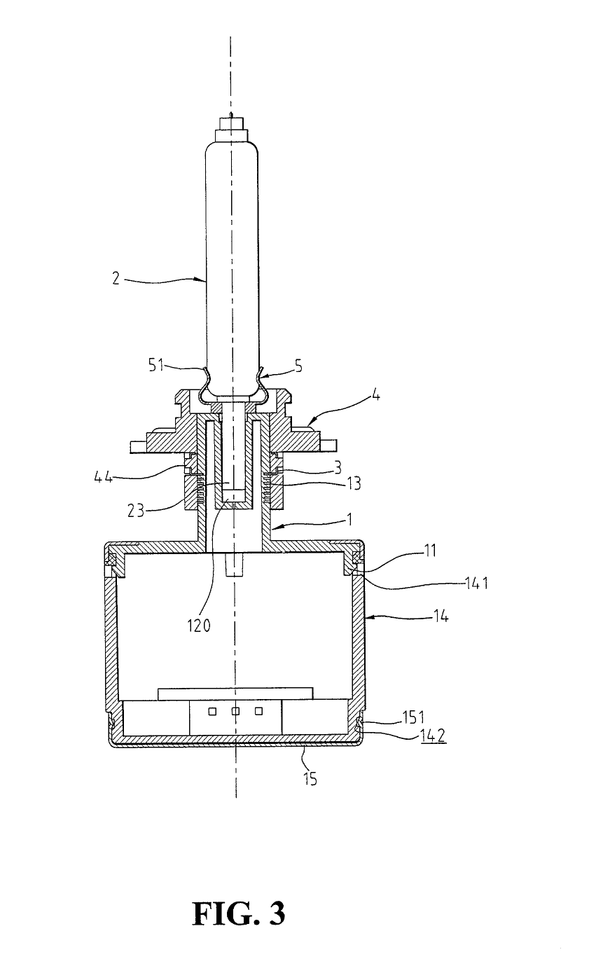

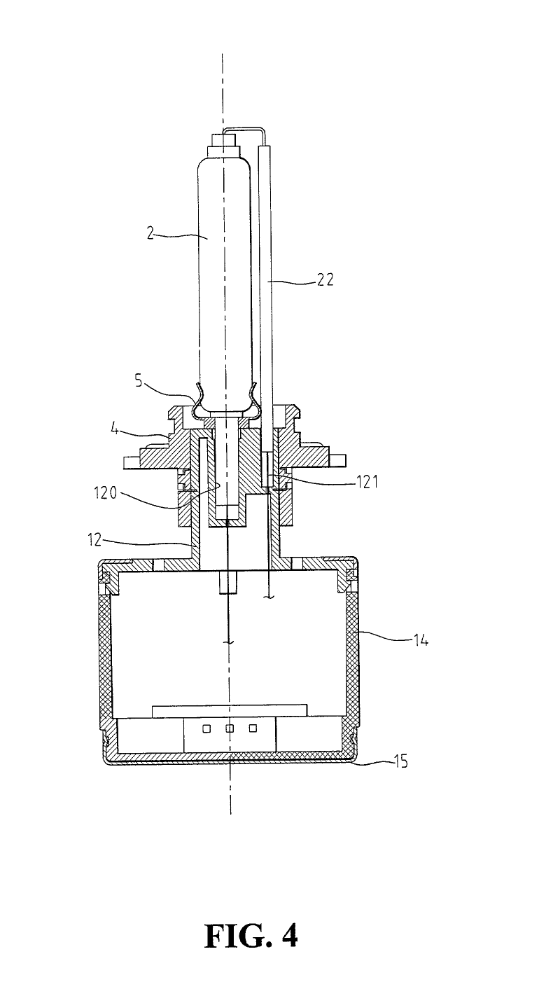

Referring to FIGS. 1 to 4, the high intensity discharge lamp assembly of the present invention comprises a base 1 having a tubular member 12 extending from a disk 10 of the base 1 and a first recess 120 is defined in the tubular member 12. A second recess 121 is defined eccentrically in the tubular member 12 and located in parallel with the first recess 120. A plurality of position slots 13 are defined in an outer periphery of the tubular member 12. A plurality of hooks 11 extend from the disk 10 of the base 1. A tubular casing 14 is connected to the disk 10 of the base 1 and a plurality of engaging holes 141 are defined through a first end of the tubular casing 14. The hooks 11 of the base 1 are engaged with the engaging holes 141. An end cap 15 is connected to a second end of the tubular casing 14. A tubular outlet 143 extends radially outward from the tubular casing 14 and communicates with an interior of the tubular casing 14 so that wires connected to the lamp 2 may extend through the tubular outlet 143. The end cap 15 has a notch 152 in which the outlet 143 is engaged with the notch 152. A plurality of dents 142 are defined in an inner periphery of the second end of the tubular casing 14 and the end cap 15 has a plurality of bosses 151 which are engaged with the dents 142.

A frame 4 has a central passage 41 and is mounted to the tubular member 12. The frame 4 has an annular slot 43 defined therethrough and a C-shaped clip 3 is engaged with the annular slot 43 and one of the position slots 13 so as to connect the tubular member 12 to the frame 4. The clip 3 has two lugs 31 and each of the lugs 31 has an aperture 32. Two protrusions 44 extend radially outward from the frame 4 and the protrusions 44 are engaged with the apertures 32 of the two lugs 31 so that the clip 3 is secured in position.

A lamp 2 has an isolation end 23 extending from a lower end of the lamp 2 and an isolation rod 22 is connected to the lamp 2 by a conductive wire 21. The isolation end 23 extends through a hole 50 of a clamp member 5 and is received in the first recess 120. The clamp member 5 has a plurality of clamp plates 51 extending from a periphery of the hole 50 so as to clamp the lamp 2. The isolation rod 22 is received in the second recess 121 of the tubular member 12 via a recess 42 defined in an inner periphery of the central passage 41 of the frame 4. The clamp member 5 has a plurality of position insertions 52 which are engaged with the first recess 120.

The position of the lamp 2 relative to the tubular member 12 of the base 1 can be adjusted by shifting the clip 3. Therefore, the focus of the lamp 2 can be adjusted whichever brands of frames are employed.

While we have shown and described the embodiment in accordance with the present invention, it should be clear to those skilled in the art that further embodiments may be made without departing from the scope of the present invention.

What is claimed is:

1. A high intensity discharge lamp assembly comprising:
a base having a tubular member extending therefrom and a first recess defined in said tubular member, a second recess defined eccentrically in said tubular member and located in parallel with the first recess;
a frame having a central passage and mounted to said tubular member;
a clamp member having a hole and a plurality of clamp plates extending from a periphery of said hole;
a lamp having an isolation end extending from a lower end of said lamp and an isolation rod connected to said lamp, said isolation end extending through said hole of said clamp member and received in said first recess, said clamp plates clamping said lamp and said isolation rod received in said second recess, and
a clip connecting said frame to said tubular member.

2. The lamp assembly as claimed in claim 1, wherein said frame has an annular slot defined therethrough and a plurality of position slots are defined in an outer periphery of said tubular member, said clip being a C-shaped member which is engaged with said annular slot and one of said position slots.

3. The lamp assembly as claimed in claim 2, wherein said clip has two lugs and each of said lugs has an aperture, two protrusions extending radially outward from said frame and said protrusions engaged with said apertures of said two lugs.

4. The lamp assembly as claimed in claim 1, wherein said clamp member has a plurality of position insertions which are engaged with said first recess.

5. The lamp assembly as claimed in claim 1 further comprising a tubular casing and a plurality of engaging holes defined through a first end of said tubular casing, a plurality of hooks extending from said base and said hooks engaged with said engaging holes.

6. The lamp assembly as claimed in claim 5, further comprising an end cap connected to a second end of said tubular casing.

7. The lamp assembly as claimed in claim 6, further comprising a tubular outlet extending radially outward from said tubular casing and communicating with an interior of said tubular casing, said end cap having a notch in which said outlet is engaged with said notch.

8. The lamp assembly as claimed in claim 6 further comprising a plurality of dents defined in an inner periphery of said second end of said tubular casing, said end cap having a plurality of bosses which are engaged with said dents.
